(19) United States
(12) Patent Application Publication
(10) Pub. No.: US 2006/0081022 A1
(43) Pub. Date: Apr. 20, 2006

(54) Baggage fastening device having an anti-reverse function

(76) Inventor: Chun Te Yu, Fusing Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/998,647

(22) Filed: Nov. 30, 2004

(30) Foreign Application Priority Data
Oct. 14, 2004 (TW) 093216366

(51) Int. Cl. E05B 73/00

(52) U.S. Cl. 70/58

(57) ABSTRACT

A baggage fastening device includes a first snapping member, a second snapping member detachably secured on the first snapping member, a strap mounted between the first snapping member and the second snapping member, and a protruding stop member mounted on the first snapping member and extended to a side of the second snapping member. Thus, the stop member restricts movement of the strap, so that the movable portion of the strap cannot be released and moved backward after the baggage is tightened by the strap, thereby preventing the strap from being loosened from the baggage so as to provide an anti-reverse effect to prevent the baggage fastening device from being loosened from the baggage.

### BACKGROUND OF THE INVENTION

1. Field of the Invention

The present invention relates to a baggage fastening device, and more particularly to a baggage fastening device for tightening or loosening a baggage.

2. Description of the Related Art

A conventional baggage fastening device in accordance with the prior art shown in FIGS. 9 and 10 comprises a first snapping member 41, a second snapping member 40 detachably secured on the first snapping member 41 and having a first end formed with a first passage 401 and a second passage 402 spaced from the first passage 401 and a second end detachably inserted into and locked in a first end of the first snapping member 41, and a strap 5 mounted between the first snapping member 41 and the second snapping member 40 and having a first end formed with a fixed portion 50 fixedly attached on a second end of the first snapping member 41 and a second end formed with a movable portion 51 extended through the first passage 401 and the second passage 402 and protruded outward from the first end of the second snapping member 40.

In operation, after the strap 5 of the conventional baggage fastening device is enclosed around a baggage 60, the second snapping member 40 is locked on the first snapping member 41 to lock the baggage fastening device as shown in FIG. 9. Then, the movable portion 51 of the strap 5 is pulled outward and is retained by the second snapping member 40 so as to tighten the strap 5, thereby binding the baggage fastening device on the baggage 60, so that the baggage 60 is fastened and locked by the baggage fastening device to prevent the baggage 6 from being opened.

However, when the first snapping member 41 of the baggage fastening device is driven to move or pivot outward relative to the baggage 60 until the movable portion 51 of the strap 5 is parallel with the strap 5 as shown in FIG. 10, the movable portion 51 of the strap 5 is released from the second snapping member 40, so that the movable portion 51 of the strap 5 is moved backward as indicated by the arrows “B”, thereby loosening the strap 5 from the baggage 60. Thus, the baggage fastening device is loosened from the baggage 60 easily, so that the baggage fastening device is inoperative.

The closest prior art references of which the applicant is aware are disclosed in the Taiwanese Patent Publication No. 188582, 457855 and 514121.

### SUMMARY OF THE INVENTION

The present invention is to mitigate and/or obviate the disadvantage of the conventional baggage fastening device.

The primary objective of the present invention is to provide a baggage fastening device having an anti-reverse function.

Another objective of the present invention is to provide a baggage fastening device that is not loosened from the baggage after the baggage is tightened by the strap.

A further objective of the present invention is to provide a baggage fastening device, wherein the stop member restricts movement of the strap, so that the movable portion of the strap cannot be released and moved backward after the baggage is tightened by the strap, thereby preventing the strap from being loosened from the baggage so as to provide an anti-reverse effect to prevent the baggage fastening device from being loosened from the baggage.

In accordance with the present invention, there is provided a baggage fastening device, comprising:

a first snapping member;

a second snapping member detachably secured on the first snapping member; and

a protruding stop member mounted on the first snapping member and extended to a side of the second snapping member.

Further benefits and advantages of the present invention will become apparent after a careful reading of the detailed description with appropriate reference to the accompanying drawings.

### BRIEF DESCRIPTION OF THE DRAWINGS

FIG. 1 is a partially cut-away perspective view of a baggage fastening device in accordance with the preferred embodiment of the present invention;

FIG. 2 is an exploded perspective view of the baggage fastening device as shown in FIG. 1;

FIG. 3 is a plan cross-sectional view of the baggage fastening device as shown in FIG. 1;

FIG. 3A is a schematic operational view of the baggage fastening device as shown in FIG. 3;

FIG. 4 is a plan cross-sectional exploded view of the baggage fastening device as shown in FIG. 3;

FIG. 5 is a plan cross-sectional view of a baggage fastening device in accordance with another embodiment of the present invention;

FIG. 6 is a partially cut-away perspective view of a baggage fastening device in accordance with another embodiment of the present invention;

FIG. 7 is a plan cross-sectional view of the baggage fastening device as shown in FIG. 6;

FIG. 8 is a partially cut-away perspective view of a baggage fastening device in accordance with another embodiment of the present invention;

FIG. 9 is a plan cross-sectional assembly view of a conventional baggage fastening device in accordance with the prior art; and

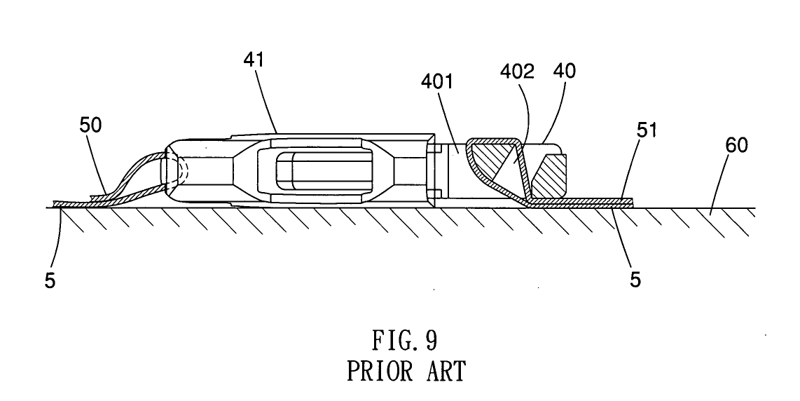

FIG. 10 is a schematic operational view of the conventional baggage fastening device as shown in FIG. 9.

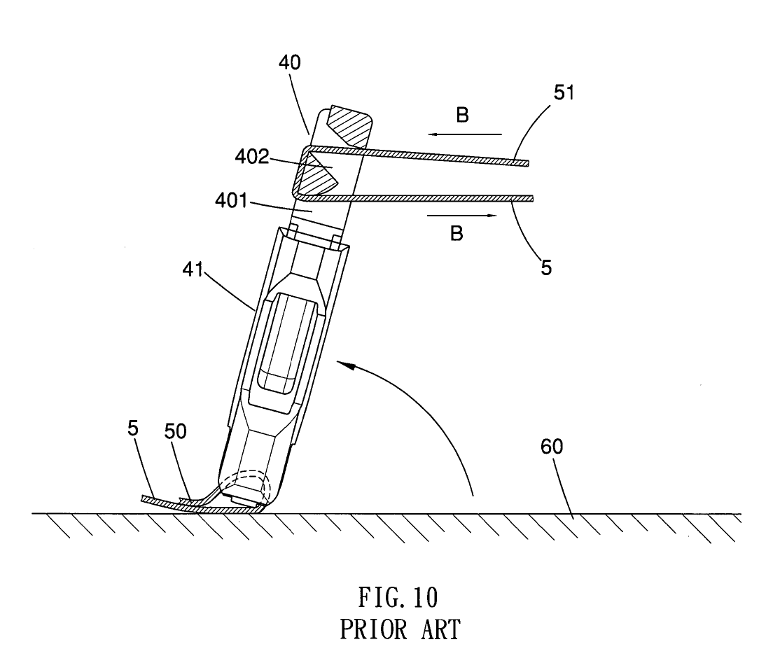

### DETAILED DESCRIPTION OF THE INVENTION

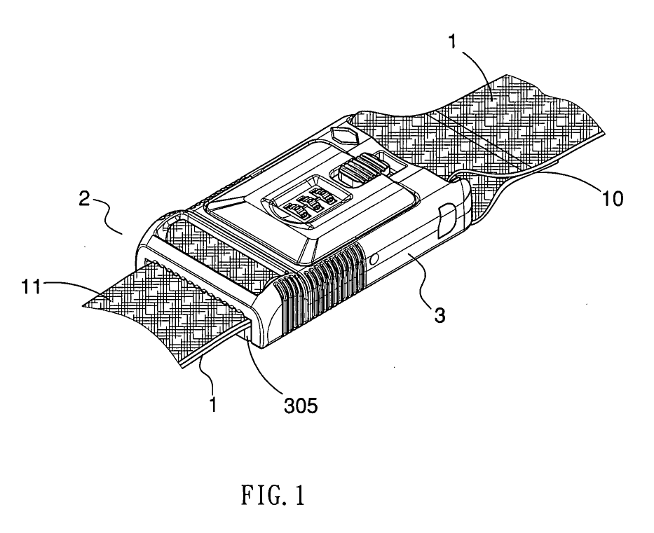

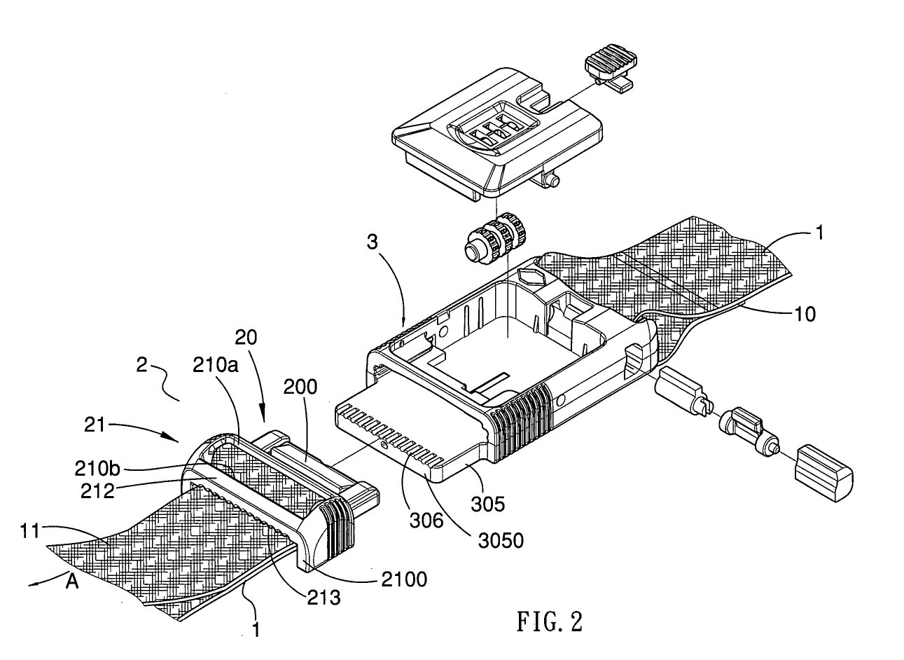

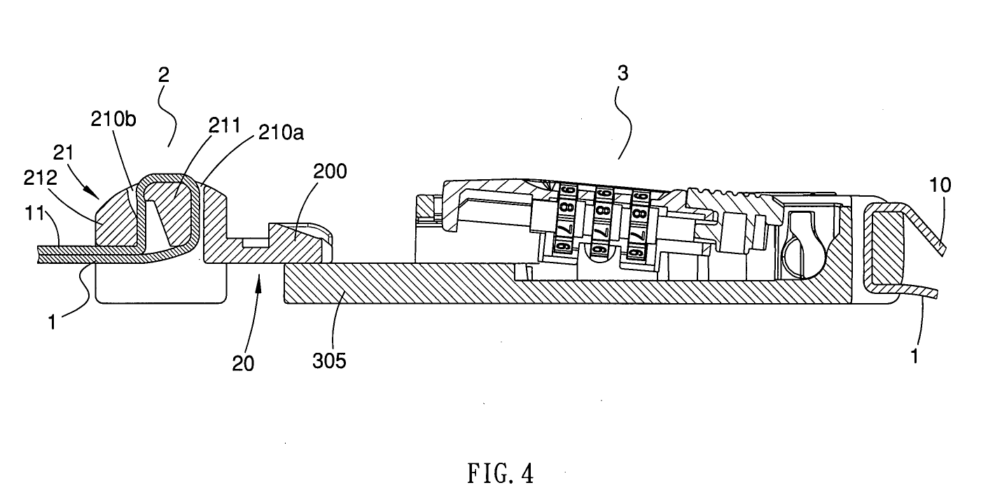

Referring to the drawings and initially to FIGS. 1-4, a baggage fastening device in accordance with the preferred embodiment of the present invention comprises a first snapping member 3, a second snapping member 2 detachably secured on the first snapping member 3, a strap 1 mounted between the first snapping member 3 and the second snapping member 2, and a protruding stop member 305 mounted on the first snapping member 3 and extended to a side of the second snapping member 2.

The second snapping member 2 has a first end 21 formed with a first passage 210a and a second passage 210b spaced from the first passage 210a and a second end 20 formed with a locking hook 200 detachably inserted into and locked in a first end of the first snapping member 3.

The strap 1 has a first end formed with a fixed portion 10 fixedly attached on a second end of the first snapping member 3 and a second end formed with a movable portion 11 extended through the first passage 210a and the second passage 210b and protruded outward from the first end 21 of the second snapping member 2.

Preferably, the first end 21 of the second snapping member 2 is provided with a first crossbar 211 and a second crossbar 212 juxtaposed to the first crossbar 211. In addition, the first passage 210a is formed between the first crossbar 211 and the second end 20 of the second snapping member 2 and the second passage 210b is formed between the first crossbar 211 and the second crossbar 212. Thus, the movable portion 11 of the strap 1 is in turn extended through the first passage 210a, the first crossbar 211, the second passage 210b and the second crossbar 212 and protruded outward from the second crossbar 212 of the first end 21 of the second snapping member 2.

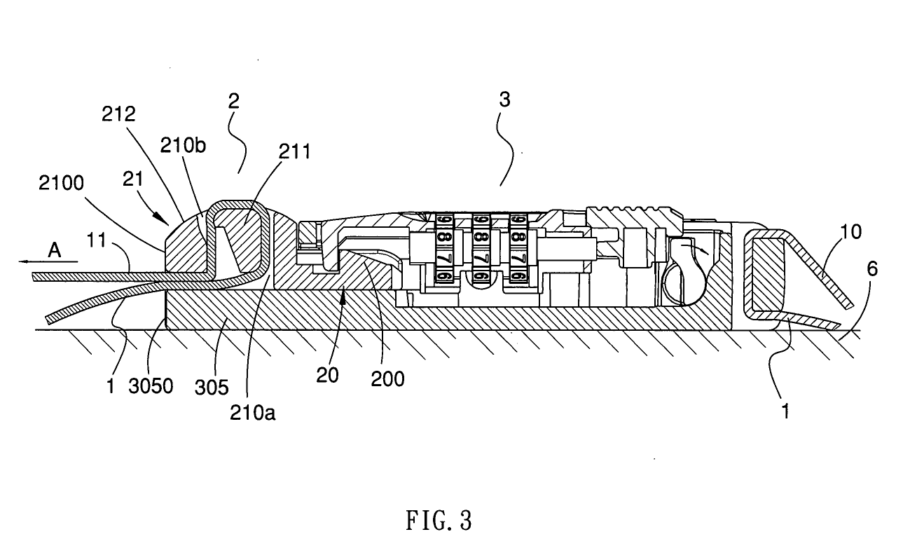

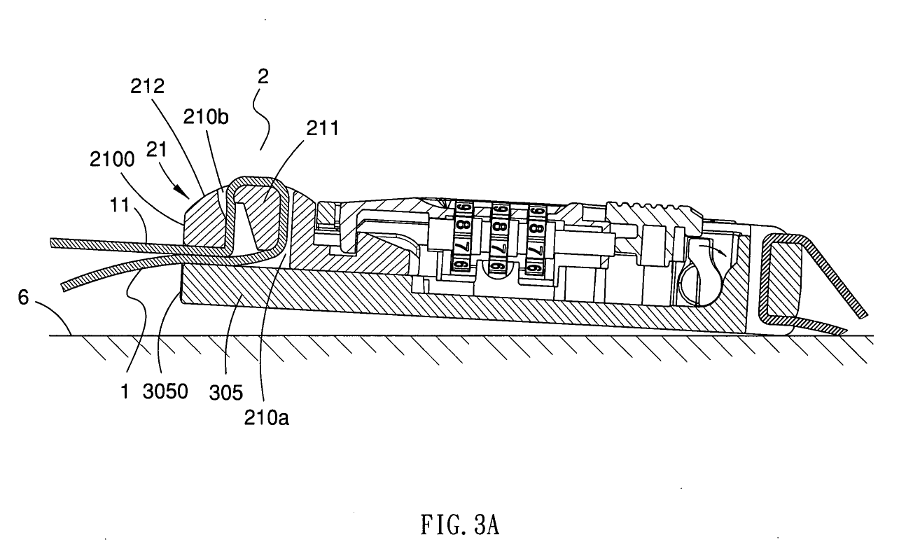

Thus, after the baggage fastening device is mounted on a baggage 6 and is locked as shown in FIG. 3, the movable portion 11 of the strap 1 is pulled outward in the direction indicated by the arrow “A” so as to tighten the strap 1, thereby binding the baggage fastening device on the baggage 6, so that the baggage 6 is fastened and locked by the baggage fastening device to prevent the baggage 6 from being opened by a person intentionally.

The stop member 305 is integrally formed on the first snapping member 3 and extended outward from a side of the first snapping member 3. The stop member 305 is rested on the strap 1 and located adjacent to the movable portion 11 of the strap 1.

Preferably, the stop member 305 is extended to the first end 21 of the second snapping member 2 and located adjacent to the first passage 210a of the first end 21 of the second snapping member 2. Alternatively, the stop member 305 is located beyond the first passage 210a of the first end 21 of the second snapping member 2. Alternatively, the stop member 305 is located adjacent to the second passage 210b of the first end 21 of the second snapping member 2. Alternatively, the stop member 305 is located beyond the second passage 210b of the first end 21 of the second snapping member 2. Alternatively, the stop member 305 is extended to the second crossbar 212 of the first end 21 of the second snapping member 2 and has an end face 3050 aligning with an end face 2100 of the first end 21 of the second snapping member 2.

The stop member 305 has a side formed with a plurality of grooves 306, and the first end 21 of the second snapping member 2 has a side formed with a plurality of protrusions 213 aligning with the grooves 306 of the stop member 305 to provide a restriction to the strap 1.

In operation, after the strap 1 of the baggage fastening device is enclosed around the baggage 6, the second snapping member 2 is locked on the first snapping member 3 to lock the baggage fastening device as shown in FIG. 3. Then, the movable portion 11 of the strap 1 is pulled outward in the direction indicated by the arrow “A” and is retained by the second crossbar 212 of the first end 21 of the second snapping member 2 so as to tighten the strap 1, thereby binding the baggage fastening device on the baggage 6, so that the baggage 6 is fastened and locked by the baggage fastening device to prevent the baggage 6 from being opened by a person intentionally.

In such a manner, the stop member 305 is extended to the second crossbar 212 of the first end 21 of the second snapping member 2 and is rested on the strap 1, so that movement of the strap 1 is restricted by the stop member 305. Thus, when the baggage fastening device is driven to move or pivot outward relative to the baggage 6 as shown in FIG. 3A, movement of the strap 1 is restricted by the stop member 305, so that the movable portion 11 of the strap 1 cannot be released from the second snapping member 2 and cannot be moved backward by pulling the strap 1, thereby preventing the strap 1 from being loosened from the baggage 6 so as to provide an anti-reverse effect to prevent the baggage fastening device from being loosened from the baggage 6.

Accordingly, the stop member 305 restricts movement of the strap 1, so that the movable portion 11 of the strap 1 cannot be released and moved backward after the baggage 6 is tightened by the strap 1, thereby preventing the strap 1 from being loosened from the baggage 6 so as to provide an anti-reverse effect to prevent the baggage fastening device from being loosened from the baggage 6.

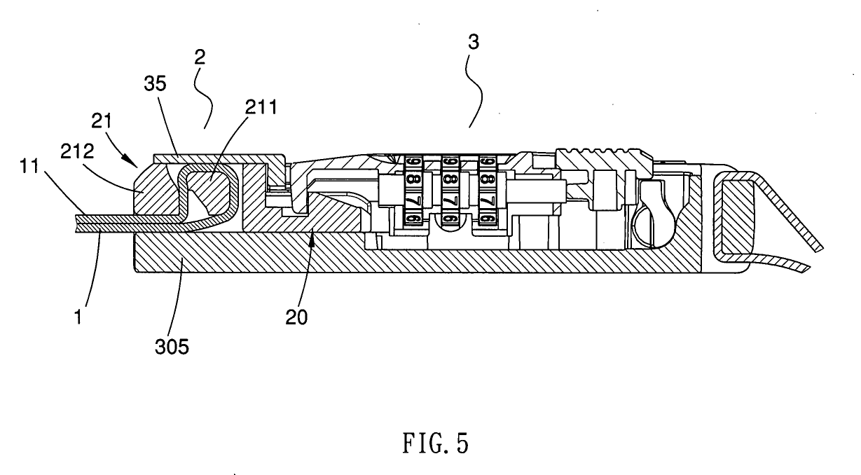

Referring to FIG. 5, the baggage fastening device further comprises a cover plate 35 mounted on the first snapping member 3 and extended to a second side of the second snapping member 2. The cover plate 35 is integrally formed on the first snapping member 3 and extended outward from a second side of the first snapping member 3. The cover plate 35 is located opposite to the stop member 305 and is rested on the strap 1. Preferably, the cover plate 35 is extended to the first end 21 of the second snapping member 2 and located beyond the first crossbar 211 of the first end 21 of the second snapping member 2.

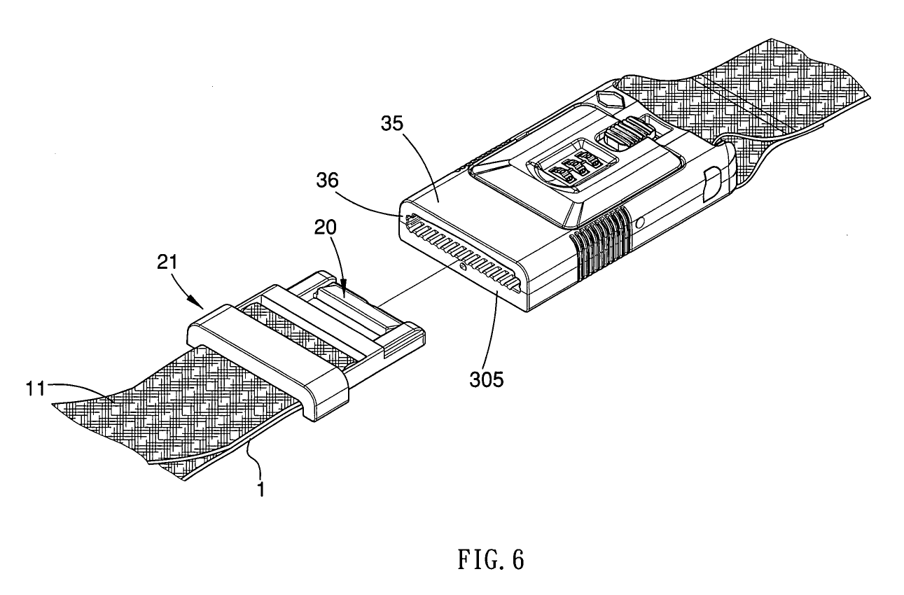

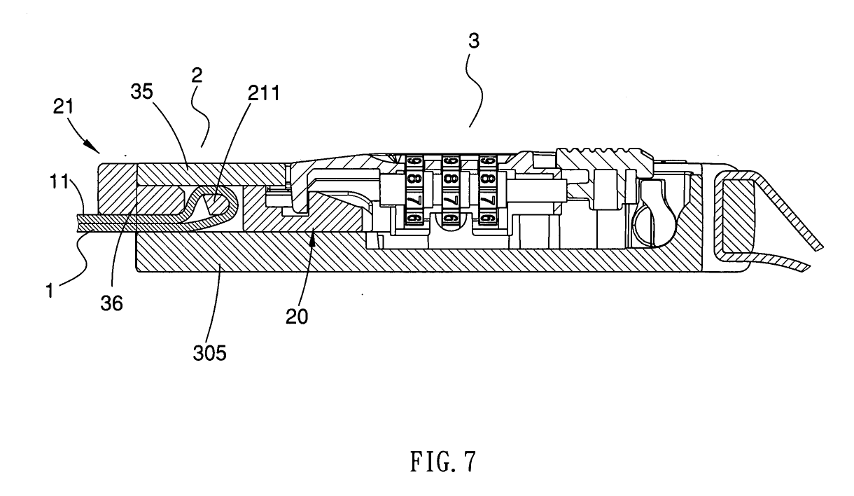

Referring to FIGS. 6 and 7, the baggage fastening device further comprises two side plates 36 mounted on the first snapping member 3 and located between the cover plate 35 and the stop member 305. Preferably, the two side plates 36 are integrally formed on and extended outward from the first snapping member 3.

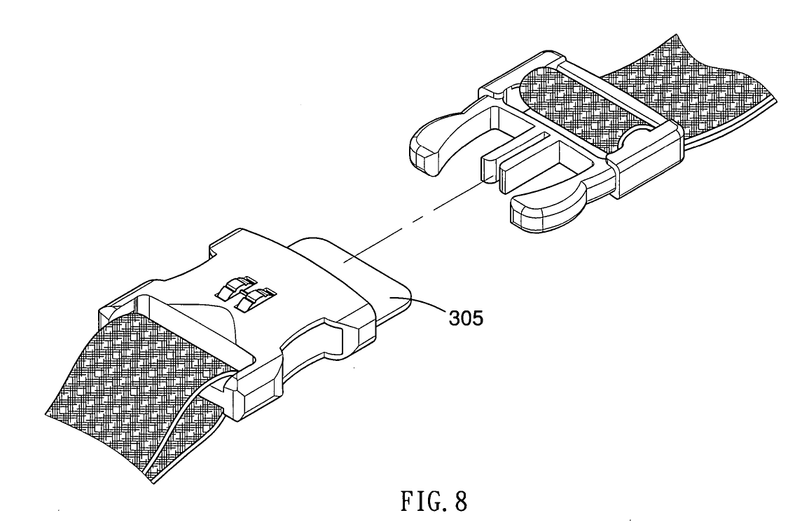

Referring to FIG. 8, the baggage fastening device has a different shape.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A baggage fastening device, comprising:
a first snapping member;
a second snapping member detachably secured on the first snapping member; and
a protruding stop member mounted on the first snapping member and extended to a side of the second snapping member.

2. The baggage fastening device in accordance with claim 1, wherein the stop member is integrally formed on the first snapping member.

3. The baggage fastening device in accordance with claim 1, wherein the stop member is extended outward from a side of the first snapping member.

4. The baggage fastening device in accordance with claim 1, wherein the second snapping member has a first end formed with a first passage and a second passage spaced from the first passage and a second end formed with a locking hook detachably inserted into and locked in a first end of the first snapping member, and the baggage fastening device further comprises a strap mounted between the first snapping member and the second snapping member and having a first end formed with a fixed portion fixedly attached on a second end of the first snapping member and a second end formed with a movable portion extended through the first passage and the second passage and protruded outward from the first end of the second snapping member.

5. The baggage fastening device in accordance with claim 4, wherein the stop member is rested on the strap.

6. The baggage fastening device in accordance with claim 4, wherein the stop member is located adjacent to the movable portion of the strap.

7. The baggage fastening device in accordance with claim 4, wherein the stop member is extended to the first end of the second snapping member.

8. The baggage fastening device in accordance with claim 4, wherein the stop member is located adjacent to the first passage of the first end of the second snapping member.

9. The baggage fastening device in accordance with claim 4, wherein the stop member is located beyond the first passage of the first end of the second snapping member.

10. The baggage fastening device in accordance with claim 4, wherein the stop member is located adjacent to the second passage of the first end of the second snapping member.

11. The baggage fastening device in accordance with claim 4, wherein the stop member is located beyond the second passage of the first end of the second snapping member.

12. The baggage fastening device in accordance with claim 4, wherein the stop member has an end face aligning with an end face of the first end of the second snapping member.

13. The baggage fastening device in accordance with claim 4, wherein the stop member has a side formed with a plurality of grooves, and the first end of the second snapping member has a side formed with a plurality of protrusions aligning with the grooves of the stop member.

14. The baggage fastening device in accordance with claim 4, wherein the first end of the second snapping member is provided with a first crossbar and a second crossbar juxtaposed to the first crossbar, the first passage is formed between the first crossbar and the second end of the second snapping member, and the second passage is formed between the first crossbar and the second crossbar.

15. The baggage fastening device in accordance with claim 14, wherein the stop member is extended to the second crossbar of the first end of the second snapping member.

16. The baggage fastening device in accordance with claim 1, further comprising a cover plate mounted on the first snapping member and extended to a second side of the second snapping member.

17. The baggage fastening device in accordance with claim 16, wherein the cover plate is integrally formed on the first snapping member and extended outward from a side of the first snapping member.

18. The baggage fastening device in accordance with claim 16, wherein the cover plate is cover plate is located opposite to the stop member.

19. The baggage fastening device in accordance with claim 14, further comprising a cover plate mounted on the first snapping member, wherein the cover plate is extended to the first end of the second snapping member and located beyond the first crossbar of the first end of the second snapping member.

20. The baggage fastening device in accordance with claim 16, further comprising two side plates mounted on the first snapping member and located between the cover plate and the stop member.
